(19) United States
(12) Patent Application Publication
(10) Pub. No.: US 2013/0301990 A1
(43) Pub. Date: Nov. 14, 2013

(54) OPTICAL WAVEGUIDE DIRECTIONAL COUPLER

(71) Applicant: HON HAI PRECISION INDUSTRY CO., LTD., Tu-Cheng (TW)

(72) Inventor: Hsin-Shun HUANG, Tu-Cheng (TW)

(73) Assignee: HON HAI PRECISION INDUSTRY CO., LTD., Tu-Cheng (TW)

(21) Appl. No.: 13/625,902

(22) Filed: Sep. 25, 2012

(30) Foreign Application Priority Data
May 11, 2012 (TW) 101116983

(51) Int. Cl. G02B 6/26

(52) U.S. Cl. 385/42

(57) ABSTRACT

An optical waveguide directional coupler includes a base and two optical waveguides formed in the base. The base has a ridge portion, and a planar portion adjacent to the ridge portion. Each of the optical waveguides includes a first straight section located in the ridge portion, a second straight section, and a curved section interconnected between the first and second straight sections. The curved sections and the second straight sections are located in the planar portion. The first straight sections are parallel with each other and define a light coupling region therebetween. The second straight sections are parallel with each other, and a distance between the second straight sections being greater than a distance between the first straight sections.

### BACKGROUND

1. Technical Field

The present disclosure relates to optical waveguide directional couplers.

2. Description of Related Art

Optical waveguide directional couplers use a light coupling region between two adjacent optical waveguides to realize optical power allocation from one of the optical waveguides to the other one of the optical waveguides.

A conventional optical waveguide directional coupler is rectangular shaped, and includes two straight optical waveguides arranged parallel with each other. However, as a light coupling effect is influenced by a light coupling region between the two optical waveguides, and the light coupling region is usually required to be 1 μm width, which makes a fabrication of the optical waveguide directional coupler difficult.

What is needed, therefore, is an optical waveguide directional coupler, which can overcome the above shortcomings.

### BRIEF DESCRIPTION OF THE DRAWINGS

Many aspects of the present optical waveguide directional coupler can be better understood with reference to the following drawings. The components in the drawings are not necessarily drawn to scale, the emphasis instead being placed upon clearly illustrating the principles of the present optical waveguide directional coupler. Moreover, in the drawings, like reference numerals designate corresponding parts throughout the several views.

FIG. 1 is a schematic isometric view of an optical waveguide directional coupler in accordance with an embodiment.

FIG. 2 is a top plan view of the optical waveguide directional coupler of FIG. 1.

### DETAILED DESCRIPTION

Embodiments of the present optical waveguide directional coupler will now be described in detail below and with reference to the drawings.

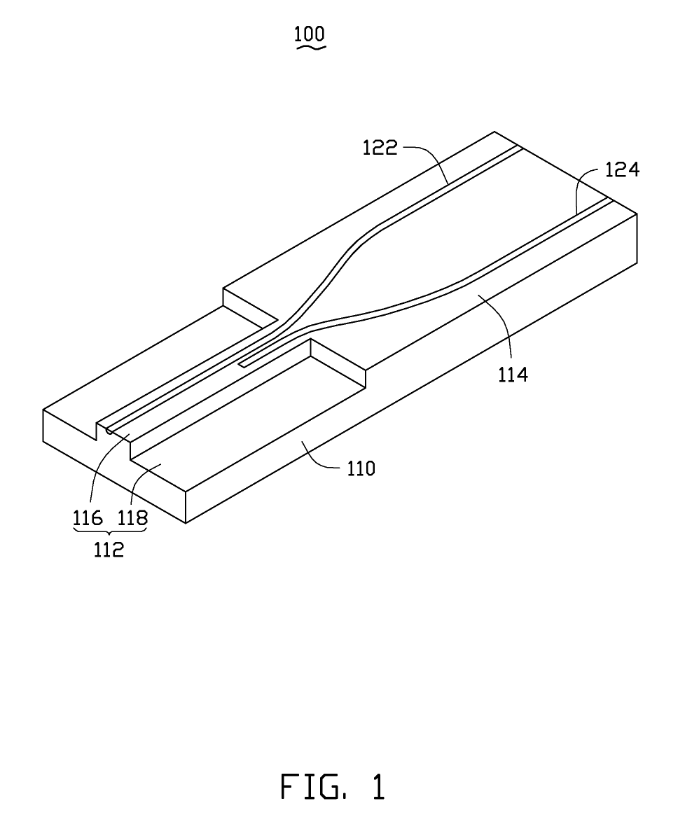

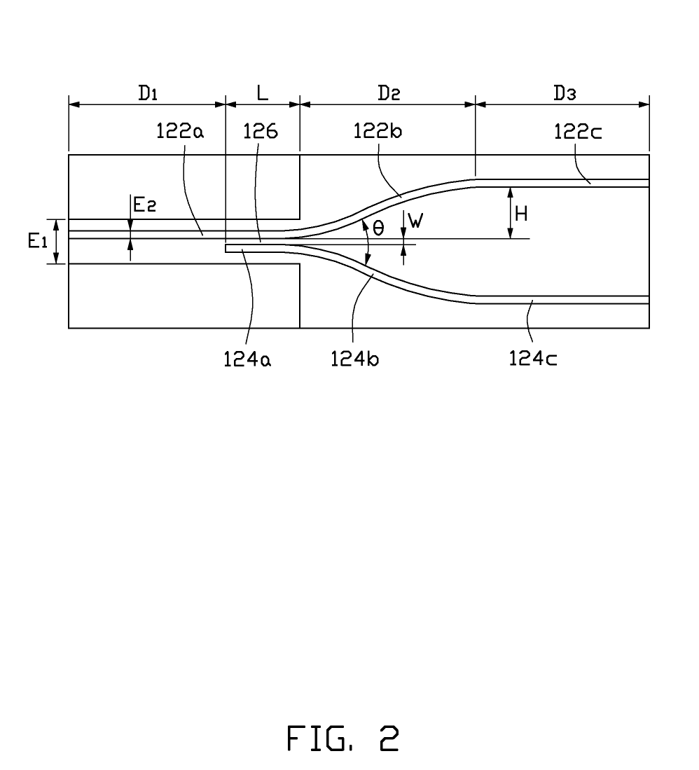

Referring to FIGS. 1 and 2, an optical waveguide directional coupler 100 of one embodiment is shown. The optical waveguide directional coupler 100 includes a base 110, and two optical waveguides 122, 124 formed in the base 110.

The base 110 includes a ridge portion 112, and a planar portion 114 adjacent to the ridge portion 112. The ridge portion 112 includes a raised portion 116 and a recessed planar portion 118, and the raised portion 116 is raised relative to the recessed planar portion 118. In the present embodiment, the recessed planar portion 118 is perpendicular to the raised portion 116. A width E₁ of the raised portion 116 is about 32 μm.

The optical waveguide 122 is exposed to both an end of the ridge portion 112 and an end of the planar portion 114 of the base 110, and the optical waveguide 124 is only exposed to the end of the planar portion 114 of the base 110. The end of the ridge portion 112 is configured as a light incident end, and the end of the planar portion 114 is configured as a light output end. The optical waveguides 122, 124 each includes a first straight section 122a, 124a located in the raised portion 116, and a curved section 122b, 124b and a second straight section 122c, 124c located in the planar portion 114. In the present embodiment, each of the optical waveguides 122, 124 has a width E₂ about 7 μm.

The first straight sections 122a, 124a are parallel with each other, the curved sections 122b, 124b are curved gradually outward from the first straight sections 122a, 124a to the second straight sections 122a, 124a, and the second straight sections 122c, 124c are parallel with each other. The first straight sections 122a, 124a cooperatively form a light coupling region 126 therebetween, wherein light enters into the first straight section 122a will allocate certain optical power to the first straight section 124a through the light coupling region 126, then certain light outputs from the second straight section 124c, and the remaining light outputs from the second straight section 122c.

In the present embodiment, the light coupling region 126 has a width W in a range 3 μm≦W≦5 μm, for example 4 μm. A length L of the light coupling region 126 can be determined according to a need of an optical power allocation from the first straight section 122a to the first straight section 124a. The first straight section 122a has a length D1 longer than the first straight section 124a, with D1 about 3500 μm.

Each of the curved sections 122b, 124b has a length D2 about 2500 μm, and each of the second straight sections 122a, 124a has a length D3 about 3500 μm. Each of the second straight sections 122c, 124c has a distance H from the light coupling region 126 about 40 μm. The curved sections 122b, 124b subtend an angle θ in a range 0°<θ≦1°, for example 0.91°.

A light refraction occurs at the ridge portion 112, not only at an interface between the optical waveguides 122, 124 and the raised portion 116, but also at an interface between the raised portion 116 and the recessed planar portion 118. That is, the ridge portion 112 helps the light field mostly distributed in the raised portion 116, and thus the light field increases between the optical waveguides 122, 124, thereby a light coupling effect is improved. In this regard, the light coupling region 126 with the width W in the range 3 μm≦W≦5 μm still can have a good coupling effect relative to a smaller width W such as 1 μm. The tolerance of greater width W of the light coupling region 126 can make a fabrication of the optical waveguide directional coupler 100 much easier.

Moreover, the greater width W of the light coupling region 126 and the configuration of the curved sections 122b, 124b avoids a very sharp corner or edge at the beginning of the curved sections 122b, 124b. In another aspect, as the curved sections 122b, 124b are curved gradually toward the second straight sections 122c, 124c, a greater gap is maintained between the second straight sections 122c, 124c, which can avoid a coupling effect between the second straight sections 122c, 124c, and thus the second straight sections 122c, 124c can output stable light.

In the optical waveguide directional coupler 100, the base 110 may contain a material selected from silicon and lithium niobate, and the optical waveguides 122, 124 may contain a material selected from titanium, zinc and nickel.

It is understood that the above-described embodiments are intended to illustrate rather than limit the disclosure. Variations may be made to the embodiments and methods without departing from the spirit of the disclosure. Accordingly, it is appropriate that the appended claims be construed broadly and in a manner consistent with the scope of the disclosure.

What is claimed is:

1. An optical waveguide directional coupler, comprising:
a base comprising a ridge portion, and a planar portion adjacent to the ridge portion; and
two optical waveguides formed in the base, each of the optical waveguides comprising a first straight section located in the ridge portion, a second straight section, and a curved section interconnected between the first and second straight sections, the curved sections and the second straight sections being located in the planar portion, the first straight sections being parallel with each other and cooperatively defining a light coupling region therebetween, the second straight sections being parallel with each other, and a distance between the second straight sections being greater than a distance between the first straight sections.

2. The optical waveguide directional coupler of claim 1, wherein the ridge portion includes a raised portion and a recessed planar portion, the raised portion raised relative to the planar portion and the first straight sections located in the ridge portion.

3. The optical waveguide directional coupler of claim 1, wherein one of the first straight sections extending through the opposite sides of the ridge portion, and the other first straight section extending from the corresponding curved portion away from the planar portion and terminating at a position midway between the opposite sides of the ridge portion.

4. The optical waveguide directional coupler of claim 3, wherein both of the second straight sections are exposed at an end surface of the planar portion facing away from the ridge portion.

5. The optical waveguide directional coupler of claim 1, wherein the light coupling region has a width in a range from 3 μm to 5 μm.

6. The optical waveguide directional coupler of claim 1, wherein the curved sections cooperatively form an angle in a range from 0° to 1°.

7. The optical waveguide directional coupler of claim 1, wherein the base contains a material selected from silicon, lithium niobate, and any combination thereof, and the optical waveguides contain a material selected from titanium, zinc, nickel and any combination thereof.
